(19) United States
(12) Patent Application Publication
(10) Pub. No.: US 2003/0130447 A1
(43) Pub. Date: Jul. 10, 2003

(54) METHOD AND CATALYST SYSTEM FOR PRODUCING POLYOLEFINS WITH A SELECTED MELT INDEX

(76) Inventors: M BRUCE WELCH, BARTLESVILLE, OK (US); DAVID W DOCKTER, BARTLESVILLE, OK (US); SYRIAC J PALACKAL, RIYADH (SA); BRYAN E HAUGER, CLAREMORE, OK (US); GYANESH P KHARE, BARTLESVILLE, OK (US)

Correspondence Address: CHEVRON PHILLIPS CHEMICAL COMPANY LP, LAW DEPARTMENT - IP, P.O BOX 4910, THE WOODLANDS, TX, 77387-4910, US

(21) Appl. No.: 09/476,458

(22) Filed: Dec. 30, 1999

(51) Int. Cl. C08F 4/44

(52) U.S. Cl. 526/129; 526/160; 526/165

(57) ABSTRACT

The present invention provides a process for producing a polymer having a desired melt index. Pursuant to the process of the present invention an inorganic oxide sample is obtained and dried to a desired extent by controlling the drying conditions. The dried inorganic oxide sample is treated with an organoaluminoxide and a metallocene to form a metallocene catalyst system and contacted with an olefin under conditions supporting polymerization to form a polyolefin sample. The drying conditions are selected to produce an inorganic oxide sample capable of generating a metallocene catalyst system which produces polymer having the desired melt index.

### FIELD OF THE INVENTION

The present invention relates to a supported metallocene catalyst system having a modified support useful for the polymerization of olefins. More particularly, but not by way of limitation, the present invention relates to a method for controlling the melt index of polyolefins prepared using a supported metallocene catalyst system by controlling the conditions under which the support is dried.

### BACKGROUND OF THE INVENTION

Metallocene catalyst systems are extensively used in a variety of polymerization systems, including the polymerization of olefins. The term “metallocene” as used herein refers to a compound containing at least one cyclopentadienyl-type group bonded to a transition metal. The transition metal is selected from Groups IVB, VB, and VIB, preferably IVB and VIB. Examples include titanium, zirconium, hafnium, chromium and vanadium. Generally, the more preferred catalysts in the polymerization of olefins are metallocenes of Zr, Hf, or Ti.

Generally, in order to obtain the highest activity from metallocene catalysts, it has been necessary to use them with an organoaluminoxane cocatalyst, such as methylaluminoxane. The resulting catalyst system is generally referred to as a homogenous catalyst system because at least part of the metallocene or the organoaluminoxane is in solution in the polymerization media. These homogenous catalysts systems have the disadvantage that when they are used under slurry polymerization conditions, they produce polymer which sticks to reactor walls during the polymerization process (generally referred to as “fouling”) and/or polymer having small particle size and low bulk density which limits the commercial utility.

Various methods have been proposed in an effort to overcome the disadvantages of the homogenous metallocene catalyst systems. One such method involves the prepolymerization of the metallocene aluminoxane catalyst system and/or supporting the catalyst system components on a porous carrier (also known as a “particulate solid” or “support”).

Another important consideration in development of metallocene catalysts is the physical characteristics of polymer generated using such catalysts. For example, it is often desirable to generate a polymer having a desired melt index for use in a particular application. There is an ongoing search for ways to control the physical characteristics, such as molecular weight or melt index, of polymer generated using metallocene catalysts. This includes an investigation into techniques for preparing such catalysts. An evaluation of these catalysts and techniques has revealed that there is still room for improvement.

One aim of the present invention is to provide a new method for preparing a supported metallocene catalyst system capable of generating polymer having desired physical characteristics, e.g., melt index.

### SUMMARY OF THE INVENTION

The present invention provides a process for producing a polymer having a desired melt index. Pursuant to the process of the present invention an inorganic oxide sample is obtained and dried to a desired extent by controlling the drying conditions. The dried inorganic oxide sample is treated with an organoaluminoxide and a metallocene to form a metallocene catalyst system and contacted with an olefin under conditions supporting polymerization to form a polyolefin sample. The drying conditions are selected to produce an inorganic oxide sample capable of generating a metallocene catalyst system which produces polymer having the desired melt index.

### DETAILED DESCRIPTION OF THE INVENTION

The present invention provides a particulate solid catalyst system useful in forming a slurry catalyst system for the polymerization of olefins having a desired melt index. Any number of supports can be employed as the particulate solid to be modified. Typically the support can be any inorganic oxide, including Groups II, III, IV or V metal oxides such as silica, alumina, silica-alumina, and mixtures thereof. Other examples of inorganic oxides are magnesia, titania, zirconia, and the like. It is within the scope of the present invention to use a mixture of one or more of the particulate solids.

The present inventors have observed that the extent and type of drying of the support used for a metallocene catalyst system influences the melt index of polyolefin produced using the supported catalyst system. Thus, partially dried and more extensively dried inorganic oxide-metallocene catalyst preparations can be used to catalyze formation of polyolefin products having a desired melt index.

In accordance with the process of the present invention, a plurality of inorganic oxide samples may be obtained, wherein each of the samples is dried under different conditions to determine the effect of such drying conditions upon the melt index of polyolefin ultimately produced. The dried samples are each treated with an organoaluminoxane and a metallocene to form a plurality of catalyst systems. Each of the metallocene catalyst systems are contacted with an olefin under conditions supporting polymerization to form a polyolefin sample for each of the catalyst systems. The melt index of each polyolefin sample is determined and information is used to determine the drying conditions that will yield polyolefin having the desired melt index.

In accordance with the present invention, the solid support is carefully dehydrated to a desired extent prior to use. Preferably, the solid is thermally dehydrated so as to contain less than 7% weight loss on ignition. Complete or partial dehydration treatment may be carried out in substantial vacuum or while purging with a dry inert gas such as nitrogen or dry air at a temperature of about 20° C. to about 1200° C., and preferably, from about 300° C. to about 800° C. Pressure considerations are usually not critical. The duration of thermal treatment can be from about 0.1 to about 24 hours.

In one preferred embodiment, the inorganic oxide support is placed in a ceramic tray which is then placed in a muffle furnace with ambient air. The temperature of the muffle furnace is increased at a rate of 10° C. per minute until the desired temperature is reached. The silica is left at the indicated temperature for the desired time period, depending on the extent of dehydration desired. After removal from the muffle furnace, the heated silicon dioxide is preferably placed in a sealed container under a dry inert atmosphere for further use.

Additional dehydration can also be accomplished by subjecting the solid to a chemical treatment to remove water and reduce the concentration of surface hydroxyl groups. Chemical treatment is generally capable of converting substantially all water and hydroxyl groups in the oxide surface to relatively inert species. Useful chemical agents are for example, trimethylaluminum, ethyl magnesium chloride, chlorosilanes such as SiCl₄, disilazane, trimethylchlorosilane, (dimethylamino) trimethylsilane and the like. Trimethylaluminum (“TMA”) is a particularly preferred chemical treatment agent for reducing the number of surface hydroxyl groups.

The chemical dehydration can be accomplished by slurrying the calcined inorganic particulate material such as, for example silica, in an inert low boiling hydrocarbon, such as for example, hexane. During the chemical dehydration treatment, the silica should be maintained in a moisture and oxygen free atmosphere. A low boiling inert hydrocarbon solution of the chemical dehydrating agent is then added to the silica slurry, such as, for example TMA. The solution is added slowly to the slurry. The temperature ranges during chemical dehydration reaction can be from about 20° C. to about 120° C., however, higher and lower temperatures can be employed. Preferably, the temperature will be from about 50° C. to about 100° C. The chemical dehydration procedure may be allowed to proceed until all the substantially reactive groups are removed from the particulate support material as indicated by cessation of gas evolution. Normally, the chemical dehydration reaction will be allowed to proceed from about 30 minutes to about 16 hours. Upon completion of the chemical dehydration, the solid particulate material may be filtered under a nitrogen atmosphere and washed one or more times with a dry, oxygen free inert solvent. The wash solvents as well as the diluents employed to form the slurry and the solution of chemical dehydrating agent can be any suitable inert hydrocarbon. Illustrative of such hydrocarbons are pentane, heptane, hexane, toluene, isopentane and the like.

The specific particle size of the support or inorganic oxide, surface area, and pore volume are not considered critical to its use in the practice of this invention. However, such characteristics often determine the amount of support to be employed in preparing the catalyst compositions, as well as affecting the particle morphology of polymers formed. The characteristics of the carrier or support must therefore be taken into consideration in choosing the same for use in the particular invention.

The modified support, prepared as described above, is useful in forming a supported metallocene catalyst system. The supported catalyst system is prepared by contacting the modified support material with a solution of a metallocene catalyst component, which has been treated with an organoaluminoxane as described more fully below, and with ethylene.

The organoaluminoxane component used in preparing the inventive solid catalyst system is an oligomeric aluminum compound having repeating units of the formula:

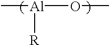

Some examples are often represented by the general formula:

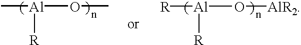

In the general aluminoxane formula, R is a C₁-C₅ alkyl radical, for example, methyl, ethyl, propyl, butyl or pentyl and “n” is an integer from 1 to about 50. Most preferably, R is methyl and “n” is at least 4. Aluminoxanes can be prepared by various procedures known in the art. For example, an aluminum alkyl may be treated with water dissolved in an inert organic solvent, or it may be contacted with a hydrated salt, such as hydrated copper sulfate suspended in an inert organic solvent, to yield an aluminoxane. Generally the reaction of an aluminum alkyl with a limited amount of water is postulated to yield a mixture of the linear and cyclic species of the aluminoxane.

A wide range of metallocenes is considered to be applicable to the present process. Particularly preferred metallocenes useful for this invention are those metallocenes discussed in U.S. Pat. No. 5,498,581, assigned to the assignee of the present invention. The metallocenes of the type contemplated as useful for the present invention include those represented by the formula:

Rₓ(Z)(Z)MeQₖ

wherein each Z is bound to Me, is individually selected and is a cyclopentadienyl-type ligand selected from substituted or unsubstituted cyclopentadienyl, indenyl, benzoindenyl, tetrahydroindenyl, benzofluorenyl, octahydrofluorenyl, and fluorenyl ligands, as well as derivatives thereof;

wherein R is a structural bridge linking the Z's and is selected from the group consisting of hydrocarbyl groups, hydrocarboxy groups, silicon containing hydrocarbyl groups, germanium containing hydrocarbyl groups, tin containing hydrocarbyl groups, phosphorus containing hydrocarbyl groups, and nitrogen containing hydrocarbyl groups each having 1 to 20 carbon atoms;

wherein Me is a metal selected from the group consisting of Group 4, 5, and 6 metals of the Periodic Table;

wherein each Q is individually selected from the group consisting of hydrogen, halogen, hydrocarbyl groups having 1 to 20 carbon atoms, alkoxy groups having 1 to 20 carbon atoms, amino groups which may or may not be substituted with up to two hydrocarbyl groups having 1 to 20 carbon atoms, a phosphorus-containing hydrocarbyl group having 1 to 20 carbon atoms, a silicon-containing hydrocarbyl group having 1 to 20 carbon atoms and an aluminum-containing hydrocarbyl group having 1 to 20 carbon atoms;

wherein x is 1 or 0; and

wherein k is a number sufficient to fill out the remaining valences of Me.

Preferred metallocenes include those metallocenes which contain a substituent which is copolymerizable with an olefin. An even more preferred group would be bridged metallocenes in which the polymerizable substituent is on the bridge. Examples of such polymerizable substituents include alkenyl and alkynel groups. Although bridged metallocenes are preferred to unbridged metallocenes, both are considered applicable to the present invention. Non-limiting examples of bridged metallocenes having fluorenyl-containing components and methods for making same are disclosed in U.S. Pat. No. 5,594,078 which is fully incorporated herein by reference.

The term fluorenyl as used herein refers to 9-fluorenyl unless specifically indicated as otherwise. Accordingly, the term fluorenyl and 9-fluorenyl should be viewed as equivalent unless indicated otherwise.

Before being contacted with the modified support, the metallocene and aluminoxane are combined in the presence of a suitable liquid to form a liquid catalyst system. The amount of aluminoxane and metallocene used in forming the liquid catalyst system can vary over a wide range. Typically, however, the molar ratio of aluminum in the aluminoxane to transition metal of the metallocene is in the range of about 1:1 to about 20,0000:1, more preferably, a molar ratio of about 50:1 to about 1000:1 is used.

It is preferred that the liquid catalyst system be prepared using an organic liquid in which the aluminoxane is at least partially soluble. The currently preferred liquids are hydrocarbons such as hexane or toluene. Typically, an aromatic liquid solvent is employed. Examples include benzene, toluene, ethyl benzene, diethylbenzene, and the like. The amount of liquid to be employed is not particularly critical. Nevertheless, the amount should preferably be such as to dissolve the product of the reaction between the metallocene and the aluminoxane, to provide desirable polymerization viscosity for pre-polymerization, and to permit good mixing. The temperature is preferably kept below that which would cause the metallocene to decompose. Typically the temperature would be in the range of −50° C. to 100° C. Preferably, the metallocene, the aluminoxane, and the liquid diluent are combined at room temperature, i.e. around 100 to 30° C. The reaction between the aluminoxane and the metallocene is relatively rapid. The reaction rate can vary depending upon the ligands of the metallocene. It is generally desired that the aluminoxane and metallocene be contacted for about one minute to about one hour. Upon completion of the reaction, a liquid catalyst system will have been formed.

The liquid catalyst system is contacted with the modified support by mixing the liquid catalyst system with the above modified support. Preferably, the liquid catalyst is added to the support with vigorous stirring. The modified support is used in an amount such that the weight ratio of the metallocene to the support is in the range of about 0.00001/1 to 1/1, more preferably 0.005/1 to 0.05/1.

Next the liquid catalyst system/support mixture is prepolymerized. The prepolymerization is conducted in the supported catalyst system, which can be a solution, a slurry, or a gel in a liquid. Typically, the prepolymerization will be conducted using an olefin. A wide range of olefins can be used for the prepolymerization, preferably one selected from nonaromatic alpha-olefins, such as ethylene and propylene. It is within the scope of the invention to use a mixture of olefins. For example, ethylene and a higher alpha olefin can be used for prepolymerization. The use of a higher alpha olefin such as 1-butene with ethylene is believed to increase the amount of copolymerization occurring between the olefin monomer and the olefinically unsaturated portion of the metallocene.

The prepolymerization can be conducted under relatively mild conditions. Typically, this would involve using low pressures and relatively low temperatures designed to prevent site decomposition resulting from high concentrations of localized heat. The prepolymerization typically occurs at temperatures in the range of about −30° C. to about +110° C., more preferably in the range of about 0° C. to about +30° C. The amount of prepolymer can be varied but typically would be in the range of from about 1 to about 95 wt. % of the resulting prepolymerized solid catalyst system, more preferably about 5 to 80 wt. %. It is generally desirable to carry out the prepolymerization to at least a point where the majority of the metallocene is in the solid rather than in the liquid to maximize the use of the metallocene.

After prepolymerization, the resulting solid prepolymerized catalyst is separated from the liquid of the reaction mixture. Various techniques known in the art can be used for carrying out this step. After separating the solid from the liquid, the resulting solid is preferably washed with a hydrocarbon and then dried using high vacuum to remove substantially all the liquids and other volatile components that might still be associated with the solid. The vacuum drying is preferably carried out under relatively mild conditions, i.e. temperatures below 100° C. More typically the prepolymerized solid is dried by subjection to a high vacuum at a temperature of about 30° C. until a substantially constant weight is achieved. A preferred technique employs at least one initial wash with an aromatic hydrocarbon such as toluene, followed by several washes with a paraffinic hydrocarbon such as pentane, and then vacuum drying.

It is within the scope of the present invention to contact the prepolymerization reaction mixture product with a liquid in which the prepolymer is sparingly soluble, i.e. a counter solvent for the prepolymer, to help cause soluble prepolymer to precipitate from the solution. Such a liquid is also useful for the subsequent washing of the prepolymerized solid. The liquid mixture resulting from the prepolymerization of the inventive solid prepolymerized catalyst can be subjected to sonification to help break up particles if desired.

Further, if desired, the recovered solid prepolymerized catalyst system can be screened to give particles having sizes that meet the particular needs for a particular type of polymerization.

Another option is to combine the recovered inventive solid prepolymerized catalyst system with an inert hydrocarbon, such as one of the types used as a wash liquid, and then to remove that liquid using a vacuum. In such a process it is sometimes desirable to subject the resulting mixture to sonification before stripping off the liquid.

The resulting solid prepolymerized metallocene containing catalyst system is useful for the polymerization of olefins. Generally, it is not necessary to add any additional aluminoxane to this catalyst system. In some cases it may be found desirable to employ small amounts of an organo aluminum compound as a scavenger for poisons. The term organo aluminum compounds include compounds such as trimethylaluminum, trimethylaluminum, diethylaluminium chloride, ethyl aluminum dichloride, ethyl aluminum sesquichloride, and the like. Trialkyl aluminum compounds are currently preferred. Also in some applications it may be desirable to employ small amounts of antistatic agents which assist in preventing the agglomeration of polymer particles during polymerization. Still further, when the inventive catalyst system is added to a reactor as a slurry in a liquid, it is sometimes desirable to add a particulate dried solid as a flow aid for the slurry. Preferably the solid has been dried using one of the methods described earlier. Inorganic oxides such as silica or polyolefin “fluff” are particularly preferred. Currently, it is preferred to use a fumed silica such as that sold under the trade name Cab-o-sil. Generally the filmed silica is dried using heat and trimethylaluminum.

The solid catalyst system is particularly useful for the polymerization of alpha-olefins having 2 to 10 carbon atoms. Examples of such olefins include ethylene, propylene, butene-1, pentene-1,3-methylbutene-1, hexenepropylene, 4-methylbutene-1,3-methylpentene-1, heptene-1, octene-1, decene-1,4,4-dimethyl-1-pentene, 4,4-diethyl-1-hexene, 3,4-dimethyl-1-hexene, and the like and mixtures thereof. The catalysts are also useful for preparing copolymers of ethylene and propylene and copolymers of ethylene or propylene and one or more higher molecular weight olefins.

The polymerizations can be carried out under a wide range of conditions depending upon the particular metallocene employed and the particular results desired. Although the inventive catalyst system is a solid, it is considered that it is useful for polymerization conducted under solution, slurry, or gas phase reaction conditions.

When the polymerizations are carried out in the presence of liquid diluents, obviously it is important to use diluents which do not have an adverse effect upon the catalyst system. Typical liquid diluents include propylene, propane, butane, isobutane, pentane, hexane, heptene, octane, cyclohexane, methylcyclohexane, toluene, xylene, and the like. Typically the polymerization temperature can vary over a wide range, temperatures typically would be in a range of about −60° C. to about 300° C., more preferably in the range of about 20° C. to about 160° C. Typically the pressure of the polymerization would be in the range of from about 1 to about 500 atmospheres or even greater. The inventive catalyst system is particularly useful for polymerizations carried out in particle form, i.e., slurry-type polymerization conditions.

The polymers produced in accord with this invention have a wide range of uses that will be apparent to those skilled in the art from the physical properties of the respective polymers. Applications such as moldings, films, adhesives, and the like are included. The present invention provides a method and catalyst system which can provide polymers tailored for specific applications.

A further understanding of the present invention, its various aspects, objects and advantages will be provided by the following examples.

### EXAMPLE

Unless otherwise specified, all preparations for experiments were carried out under an inert gas atmosphere. All solvents were purchased from commercial sources and dried as appropriate over activated alumina. Trimethylaluminum (TMA) was purchased as a 2.0 M or 15 wt % solution in toluene from commercial sources. Methylaluminoxane (MAO) was purchased from commercial sources as a 10 or 30 wt % solution in toluene.

The silicon dioxide used for all experiments was Davison 952×1836. For each example, an approximately 150 gram portion of the silicon dioxide was put in a ceramic tray and placed in a muffle furnace with ambient air. The temperature of the furnace was increased at a rate of 10° C./min. until the desired temperature was reached. The silica dioxide was then held at this temperature for a prescribed period of time.

A plurality of catalysts systems were prepared using the aforementioned procedure with silica dried at varying temperatures. Consistent with the object of the present invention, each catalyst system prepared was then evaluated for its effect upon the polymerization of ethylene.

Each polymerization was conducted in a one gallon, stirred autoclave reactor. A small amount of the catalyst system was combined with two liters of isobutane in the reactor. The reactor temperature was raised to about 88° C. and hydrogen was added. The amount of hydrogen was determined as a 10 psi pressure drop on a 300 cc pressure vessel. The reactor was brought to a polymerization temperature of about 90° C. Then ethylene was introduced into the reactor so that the total reactor pressure was about 450 psig. The reactor pressure was maintained at 450 psig throughout a one-hour run by continuous introduction of ethylene. Then the reactor was vented to remove the volatile components and the polymer was collected as a dry fluff.

The melt index of each polymerized product was evaluated with respect to the temperature at which the silica was dried. The Melt Index (MI) of the resins in the examples was determined using ASTM 01238 Condition E; High Load Melt Index by ASTM 01238 Condition E; and Density using ASTM D1505-68.

### Catalyst 1

### Silica Dried at 30° C.

Two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) to 10.5 ml of MAO (10 wt % in toluene) and stirring for 15 minutes. The premixed catalyst solution was then added to the silica slurry, and the mixture was stirred for 15 minutes.

With continual stirring of the premixed catalyst solution and silica slurry mixture, gaseous ethylene was added at 5 psig and room temperature. After 40 minutes of interaction with the ethylene, the mixture weighed an additional 1.66 grams.

The mixture was then washed once with a 20 ml portion of toluene and twice with 20 ml portions of pentane. The filtrate was then dried for 1 hour under a high vacuum.

The above procedure produced an isolated solid product weighing 3.68 grams. The melt index of the resulting resin product was 0.54 dg/min.

### Catalyst 2

### Silica Dried at 200° C.

In this run, two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) and 10.5 ml of MAO (10 wt % in toluene) and stirring for 15 minutes. The premixed solution was then added to the silica-toluene slurry and stirred for 15 minutes.

Upon completion of stirring, gaseous ethylene was added at 5 psig and room temperature to the premixed catalyst solution and silica slurry mixture. After 1 hour and 42 minutes of contact, the mixture weighed an additional 1.64 grams.

The mixture was then washed once with a 20 ml portion of toluene and twice with 20 ml portions of pentane. The filtrate was then dried for 1 hour under a high vacuum.

The above procedure produced an isolated solid product weighing 3.12 grams. The melt index of the resulting resin product was 0.69 dg/min.

### Catalyst 3

### Silica Dried at 400° C.

In this run, two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) and 10.5 ml of MAO (10 wt % in toluene) and stirring for 15 minutes. The premixed solution was then added to the silica-toluene slurry and stirred for 15 minutes.

Upon completion of stirring, gaseous ethylene was added at 5 psig and room temperature to the premixed catalyst solution and silica slurry mixture. After 1 hour and 6 minutes of contact, the mixture weighed an additional 1.61 grams.

The mixture was then washed once with a 20 ml portion of toluene and twice with 20 ml portions of pentane. The filtrate was then dried for 1 hour under a high vacuum.

The above procedure produced an isolated solid product weighing 3.25 grams. The melt index of the resulting resin product was 0.88 dg/min.

### Catalyst 4

### Silica Dried at 600° C.

In this run, two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) and 10.5 ml of MAO (10 wt % in toluene) and stirring for 15 minutes. The premixed solution was then added to the silica-toluene slurry and stirred for 15 minutes.

Upon completion of stirring, gaseous ethylene was added at 5 psig and room temperature to the premixed catalyst solution and silica slurry mixture. After 1 hour and 20 minutes of interaction, the mixture weighed an additional 1.60 grams.

The mixture was then washed once with a 20 ml portion of toluene and twice with 20 ml portions of pentane. The filtrate was then dried for 1 hour under a high vacuum.

The above procedure produced an isolated solid product weighing 3.54 grams. The melt index of the resulting resin product was 1.05 dg/min.

### Catalyst 5

### Silica Dried at 800° C.

In this run, two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) and 10.5 ml of MAO (10 wt % in toluene) and stirring for 15 minutes. The premixed solution was then added to the silica-toluene slurry and stirred for 15 minutes.

Upon completion of stirring, gaseous ethylene was added at 5 psig and room temperature to the premixed catalyst solution and silica slurry mixture. After 1 hour and 20 minutes of contact, the mixture weighed an additional 1.94 grams.

The mixture was then washed once with a 20 ml portion of toluene and twice with 20 ml portions of pentane. The filtrate was then dried for 1 hour under a high vacuum.

The above procedure produced an isolated solid product weighing 3.47 grams. The melt index of the resulting resin product was 1.32 dg/min.

### Catalyst 6

### Silica Dried at 954° C.

In this run, two grams of the TMA treated silica were slurried in toluene. A premixed solution was prepared by adding 36.4 mg of the metallocene (1-cyclopentadienyl-1-flourenyl-1-but-3-enyl-1-methyl methane zirconium dichloride) and 10.5 ml of MAO (10 wt % in toluene) and stirring for 15 minutes. The premixed solution was then added to the silica-toluene slurry and stirred for 15 minutes.

Upon completion of stirring, gaseous ethylene was added at 5 psig and room temperature to the premixed catalyst solution and silica slurry mixture. After 1 hour and 20 minutes of contact, the mixture weighed an additional 1.92 grams.

The mixture was then washed once with a 20 ml portion of toluene and twice with 20 ml portions of pentane. The filtrate was then dried for 1 hour under a high vacuum.

The above procedure produced an isolated solid product weighing 3.73 grams. The melt index of the resulting resin product was 3.36 dg/min.

TABLE 1
DRYING TEMPERATURE STUDY

| | | | MI | HLMI | | | | | |
|---|---|---|---|---|---|---|---|---|---|
| Cat. | DRYING | PROD | dg/ | dg/ | HLMI | Mw | Mn | Den. | |
| No. | TEMP. | g/g/hr | mm | min | /MI | x10⁻³ | x10⁻³ | g/cc | HI |
| 1 | 30° C. | 4960 | 0.54 | 12.48 | 23 | 107 | 38.5 | 0.9444 | 2.8 |
| 2 | 200° C. | 8030 | 0.69 | 16.25 | 24 | 95.7 | 30.9 | 0.9436 | 3.1 |
| 3 | 400° C. | 11100 | 0.88 | 18.06 | 21 | 105 | 40.1 | 0.9442 | 3.1 |
| 4 | 600° C. | 9330 | 1.05 | 16.37 | 16 | 105 | 41.3 | 0.9442 | 2.6 |
| 5 | 800° C. | 11070 | 1.32 | 22.16 | 17 | 96.6 | 41.0 | 0.9456 | 2.4 |
| 6 | 954° C. | 9660 | 3.36 | 71.69 | 21 | 72.9 | 22.5 | 0.9507 | 3.2 |

As can be seen from Table 1 and Examples 1-6, conditions of drying the solid phase inorganic oxide-metallocene catalyst results in catalyst systems yielding polyolefins having different physical characteristics. As the drying temperature for the silica increases, the melt index (“MI”) increases.

It will be clear that the present invention is well adapted to attain the ends and advantages mentioned as well as those inherent therein. While presently preferred embodiments have been described for purposes of disclosure, numerous changes may be made which will readily suggest themselves to those skilled in the art and which are encompassed in the spirit of the invention disclosed and as defined in the appended claims.

That which is claimed is:

1. In a process in which a polymer is produced by contacting an olefin with a solid particulate catalyst system prepared by drying a particulate inorganic oxide, combining the inorganic oxide with an organoaluminoxane and a metallocene, and contacting the resulting mixture with an olefin under prepolymerization conditions to form a solid prepolymerized particulate catalyst system, the improvement comprises drying the inorganic oxide to the extent necessary to provide a catalyst system which produces the polymer having the desired melt index.

2. The process of claim 1 wherein the inorganic oxide is dried by a process which comprises the step of thermal treatment.

3. The process of claim 2 wherein thermal treatment of the inorganic oxide comprises calcining.

4. The process of claim 2 wherein inorganic oxide is thermally dried at a temperature of between about 20° C. and about 1000° C.

5. The process of claim 2 wherein the process of drying the inorganic oxide further comprises the step of chemically treating the inorganic oxide by contact with a chemical dehydrating agent.

6. The process of claim 5 wherein the chemical dehydrating agent is selected from the group consisting of trimethylaluminum, ethyl magnesium chloride and chlorosilanes.

7. The process of claim 5 wherein the chemical dehydrating agent is trimethylaluminum.

8. The process of claim 1 wherein the process of drying the inorganic oxide sample further comprises the step of chemically treating the inorganic oxide by contact with a chemical dehydrating agent.

9. The process of claim 5 wherein the inorganic oxide is selected from the group consisting of Group II, III, IV or V metal oxides.

10. The process of claim 5 wherein the inorganic oxide is selected from the group consisting of silica, alumina, silica-alumina, and mixtures thereof.

11. The process of claim 5 wherein the inorganic oxide is silica.

12. The process of claim 9 where the metallocene is defined further as having two cyclopentadienyl-type ligands.

13. The process of claim 12 wherein the cyclopentadienyl-type ligands are selected from substituted or unsubstituted cyclopentadienyl, indenyl, benzoindenyl, tetrahydroindenyl, benzofluorenyl, octahydrofluorenyl, and fluorenyl ligands.

14. The process of claim 9 wherein the metallocene is selected from the group consisting of metallocenes which are in accordance with the formula
Rₓ(Z)(Z)MeQₖ
wherein each Z is bound to Me, is individually selected and is a cyclopentadienyl-type ligand selected from substituted or unsubstituted cyclopentadienyl, indenyl, benzoindenyl, tetrahydroindenyl, benzofluorenyl, octahydrofluorenyl, and fluorenyl ligands, as well as derivatives thereof;
wherein R is a structural bridge linking the Z's and is selected from the group consisting of hydrocarbyl groups, hydrocarboxy groups, silicon containing hydrocarbyl groups, germanium containing hydrocarbyl groups, tin containing hydrocarbyl groups, phosphorus containing hydrocarbyl groups, and nitrogen containing hydrocarbyl groups each having 1 to 20 carbon atoms;
wherein Me is a metal selected from the group consisting of Group 4, 5, and 6 metals of the Periodic Table;
wherein each Q is individually selected and is selected from the group consisting of hydrogen, halogens, hydrocarbyl groups having 1 to 20 carbon atoms, alkoxy groups having 1 to 20 carbon atoms, amino groups which may or may not be substituted with up to two hydrocarbyl groups having 1 to 20 carbon atoms, a phosphorus-containing hydrocarbyl group having 1 to 20 carbon atoms, a silicon-containing hydrocarbyl group having 1 to 20 carbon atoms and an aluminum-containing hydrocarbyl group having 1 to 20 carbon atoms;
wherein x is 1 or 0; and
wherein k is a number sufficient to fill out the remaining valences of Me.

15. The process of claim 9 wherein the metallocene is further selected from the group consisting of metallocenes which contain a substituent which is copolymerizable with an olefin.

16. The process of claim 9 wherein the metallocene is selected from the group consisting of bridged metallocenes containing a substituent which is copolymerizable with an olefin and wherein the substituent is located on the bridge.

17. The process of claim 14 wherein the organoaluminoxane is selected from the group consisting of oligomeric aluminum compounds having repeating units of the formula 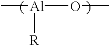
wherein R is a C₁-C₅ alkyl radical.

18. The process of claim 14 wherein the organoaluminoxane is methylaluminoxane.

19. A process for preparing a supported metallocene catalyst system useable to catalyze formation of polyolefins having desired physical characteristics for an end use comprising the steps of:
(a) obtaining a plurality of inorganic oxide samples, each dried under different conditions;
(b) treating each of said dried inorganic oxide samples with an organoaluminoxide and a metallocene to form a plurality of catalyst systems;
(c) contacting each of said metallocene catalyst systems with an olefin under conditions supporting polymerization to form a polyolefin sample from each catalyst system;
(d) determining certain physical characteristics of each polyolefin sample; and
(e) preparing a metallocene catalyst system yielding polyolefin having the desired physical characteristics by utilizing drying conditions determined from information gathered in steps (a) through (d).

20. The process of claim 19 wherein each of the inorganic oxide samples are dried by a process which comprises the step of thermal treatment.

21. The process of claim 19 wherein each of the inorganic oxide samples are thermally dried at different temperatures between about 20° C. and about 1000° C.

22. The process of claim 21 wherein the process of drying the inorganic oxide samples further comprises the step of chemically treating the inorganic oxide by contact with a chemical dehydrating agent.

23. The process of claim 22 wherein the chemical dehydrating agent is selected from the group consisting of trimethylaluminum, ethyl magnesium chloride and chlorosilanes.

24. The process of claim 22 wherein the chemical dehydrating agent is trimethylaluminum.

25. The process of claim 19 wherein the process of drying the inorganic oxide samples comprises the step of chemically treating the inorganic oxide by contact with a chemical dehydrating agent.

26. The process of claim 19 wherein the inorganic oxide is selected from the group consisting of Group II, III, IV or V metal oxides.

27. The process of claim 19 wherein the inorganic oxide is selected from the group consisting of silica, alumina, silica-alumina, and mixtures thereof.

28. The process of claim 19 wherein the inorganic oxide is silica.

29. The process of claim 19 where the metallocene is defined further as having two cyclopentadienyl-type ligands.

30. The process of claim 29 wherein the cyclopentadienyl-type ligands are selected from substituted or unsubstituted cyclopentadienyl, indenyl, benzoindenyl, tetrahydroindenyl, benzofluorenyl, octahydrofluorenyl, and fluorenyl ligands.

32. The process of claim 18 wherein the metallocene is selected from the group consisting of metallocenes which are in accordance with the formula
Rₓ(Z)(Z)MeQₖ
wherein each Z is bound to Me, is individually selected and is a cyclopentadienyl-type ligand selected from substituted or unsubstituted cyclopentadienyl, indenyl, benzoindenyl, tetrahydroindenyl, benzofluorenyl, octahydrofluorenyl, and fluorenyl ligands, as well as derivatives thereof,
wherein R is a structural bridge linking the Z's and is selected from the group consisting of hydrocarbyl groups, hydrocarboxy groups, silicon containing hydrocarbyl groups, germanium containing hydrocarbyl groups, tin containing hydrocarbyl groups, phosphorus containing hydrocarbyl groups, and nitrogen containing hydrocarbyl groups each having 1 to 20 carbon atoms;
wherein Me is a metal selected from the group consisting of Group 4, 5, and 6 metals of the Periodic Table;
wherein each Q is individually selected and is selected from the group consisting of hydrogen, halogens, hydrocarbyl groups having 1 to 20 carbon atoms, alkoxy groups having 1 to 20 carbon atoms, amino groups which may or may not be substituted with up to two hydrocarbyl groups having 1 to 20 carbon atoms, a phosphorus-containing hydrocarbyl group having 1 to 20 carbon atoms, a silicon-containing hydrocarbyl group having 1 to 20 carbon atoms and an aluminum-containing hydrocarbyl group having 1 to 20 carbon atoms;
wherein x is 1 or 0; and
wherein k is a number sufficient to fill out the remaining valences of Me.

33. The process of claim 18 wherein the organoaluminoxane is selected from the group consisting of oligomeric aluminum compounds having repeating units of the formula 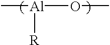
wherein R is a C₁-C₅ alkyl radical.

34. The process of claim 18 wherein the organoaluminoxane is methylaluminoxane.

35. A process for producing a polymer having a desired melt index, comprising:
(a) obtaining an inorganic oxide sample;
(b) drying said inorganic oxide sample to a desired extent by controlling the drying conditions;
(c) treating said dried inorganic oxide sample with an organoaluminoxide and a metallocene to form a metallocene catalyst system;
(d) contacting said metallocene catalyst system with an olefin under conditions supporting polymerization to form a polyolefin sample; and
(e) wherein the drying conditions are selected to produce an inorganic oxide sample capable of generating a metallocene catalyst system which produces polymer having the desired melt index.
